(19) United States
(12) Patent Application Publication
(10) Pub. No.: US 2023/0281496 A1
(43) Pub. Date: Sep. 7, 2023

(54) EQUILIBRIUM SOLUTION SEARCHING METHOD AND INFORMATION PROCESSING APPARATUS

(71) Applicant: Fujitsu Limited, Kawasaki-shi (JP)

(72) Inventors: Hayato DAN, Yokohama (JP); Masatoshi OGAWA, Zama (JP); Katsumi HOMMA, Kawasaki (JP); Natsuki ISHIKAWA, Yamato (JP)

(73) Assignee: Fujitsu Limited, Kawasaki-shi (JP)

(21) Appl. No.: 18/063,270

(22) Filed: Dec. 8, 2022

(30) Foreign Application Priority Data
Mar. 3, 2022 (JP) 2022-032230

(51) Int. Cl. G06N 7/01

(52) U.S. Cl. CPC G06N 7/01; G06Q 30/0283

(57) ABSTRACT

An information processing apparatus determines a group, which includes at least two nodes, based on similarity between a plurality of first behavior sets using node information which indicates the plurality of first behavior sets corresponding to the plurality of nodes. The information processing apparatus assigns a second behavior set to the group. The information processing apparatus calculates an evaluation value for each behavior included in the second behavior set without calculating evaluation values for behaviors included in the at least two first behavior sets corresponding to the at least two nodes. The information processing apparatus calculates a probability distribution of the behaviors included in the second behavior set based on the evaluation values.

### CROSS-REFERENCE TO RELATED APPLICATION

This application is based upon and claims the benefit of priority of the prior Japanese Patent Application No. 2022-032230, filed on Mar. 3, 2022, the entire contents of which are incorporated herein by reference.

### FIELD

The embodiments discussed herein are related to an equilibrium solution searching method and an information processing apparatus.

### BACKGROUND

In situations where each of a plurality of nodes stochastically selects one behavior out of a plurality of potential behaviors, an information processing apparatus may search for an equilibrium solution for a probability distribution for the plurality of behaviors. A simulation structure for the above situation is sometimes referred to as “evolutionary game theory”. A plurality of behaviors that are combined according to a certain probability distribution are sometimes referred to as a “mixed strategy”.

As one example, a dynamics calculation, such as replicator dynamics or regret minimization dynamics, calculates an evaluation value for each of a plurality of behaviors according to a certain probability distribution and updates the probability distribution based on the calculated evaluation values. Replicator dynamics increases the probability of a behavior with an evaluation value that is above an average evaluation value, and decreases the probability of a behavior with an evaluation value that is below the average evaluation value. Regret minimization dynamics interprets the difference between the evaluation value of a certain behavior and the maximum evaluation value for a plurality of behaviors as a “regret”, and updates the probability distribution to minimize the average regret.

Note that a behavior determination method has been proposed where a plurality of computers connected to a network each use game theory to autonomously determine whether to execute a task by themselves or to request another computer to perform the task. A scheduling method has also been proposed in which jobs are scheduled using a strategy that integrates Minimax and Nash equilibrium. A strategy formulating method has also been proposed in which data relating to the behaviors of competitors is collected from a network and a cooperative-competitive strategy is formulated based on Bayesian game theory. A matching method has also been proposed in which a plurality of applicants and a plurality of application targets are matched by finding a subgame perfect equilibrium.

See, for example, Japanese Laid-open Patent Publication No. H09-297690, U.S. Patent Application Publication No. 2012/0315966, U.S. Patent Application Publication No. 2017/0169378, and Japanese Laid-open Patent Publication No. 2019-67158.

### SUMMARY

According to an aspect, there is provided a non-transitory computer-readable recording medium storing therein a computer program that causes a computer to execute a process including: determining a group, which includes at least two nodes out of a plurality of nodes, based on similarity between a plurality of first behavior sets using node information which indicates the plurality of first behavior sets corresponding to the plurality of nodes, wherein each first behavior set includes at least two behaviors capable of being selected; assigning a second behavior set to the group; calculating an evaluation value for each behavior included in the second behavior set without calculating evaluation values for behaviors included in the at least two first behavior sets corresponding to the at least two nodes; and calculating a probability distribution of the behaviors included in the second behavior set based on the evaluation values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts an information processing apparatus according to a first embodiment;

FIG. 2 is a block diagram depicting example hardware of the information processing apparatus;

FIG. 3 depicts one example of players in a simulation;

FIG. 4 depicts one example of a strategy table;

FIG. 5 depicts an example of a strategy table after grouping;

FIG. 6 depicts an example of a probability table;

FIG. 7 depicts example sampling of strategies from mixed strategies;

FIG. 8 is a block diagram depicting example functions of an information processing apparatus; and

FIG. 9 is a flowchart depicting the processing procedure of a search for an equilibrium solution.

### DESCRIPTION OF EMBODIMENTS

An information processing apparatus may search for an equilibrium solution in a situation where a plurality of nodes have different behavior sets. In this case, it would be conceivable for the information processing apparatus to calculate an evaluation value for every potential behavior of every node and to calculate the probability distributions of the behavior sets of every node. However, in that case, the information processing apparatus will calculate evaluation values for a large number of potential behaviors, which increases the load when calculating evaluation values.

Several embodiments will be described below with reference to the accompanying drawings.

### First Embodiment

A first embodiment will now be described.

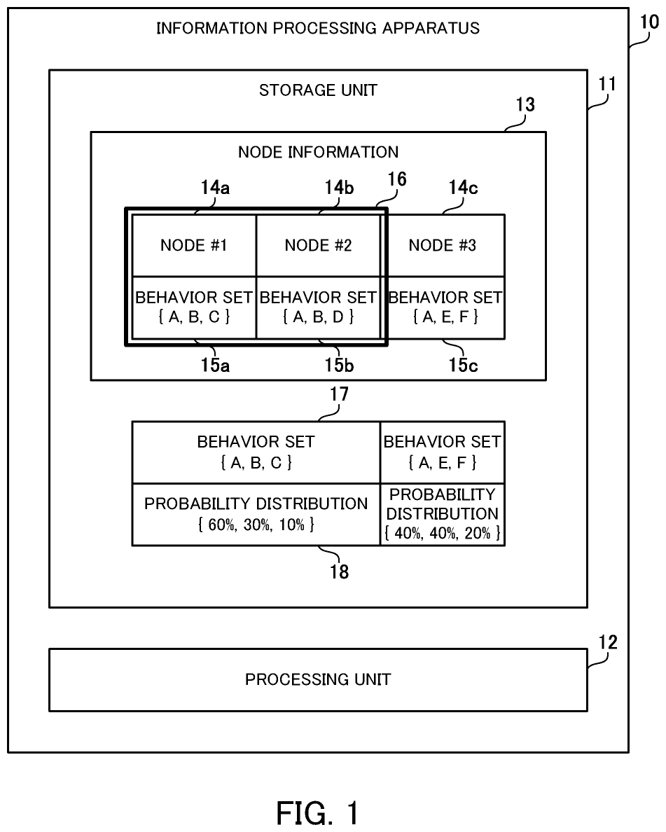

FIG. 1 depicts an information processing apparatus according to the first embodiment.

An information processing apparatus 10 according to the first embodiment searches for an equilibrium solution for a probability distribution for a plurality of behaviors in a situation where each of a plurality of nodes stochastically select one behavior out of a plurality of potential behaviors. The information processing apparatus 10 calculates an evaluation value for each behavior and calculates the probability of each behavior being selected based on the evaluation value. As the algorithm that calculates the probability distribution from the evaluation values, it is possible to use replicator dynamics or regret minimization dynamics. The information processing apparatus 10 may be a client apparatus or a server apparatus. The information processing apparatus 10 may be referred to as a “computer”, an “equilibrium solution searching apparatus”, or a “simulation apparatus”.

The information processing apparatus 10 includes a storage unit 11 and a processing unit 12. The storage unit 11 may be a volatile semiconductor memory, such as a random access memory (RAM), or may be non-volatile storage, such as a hard disk drive (HDD) or flash memory. As examples, the processing unit 12 is a processor such as a central processing unit (CPU), a graphics processing unit (GPU), or a digital signal processor (DSP). The processing unit 12 may include an electronic circuit such as an application specific integrated circuit (ASIC) or a field programmable gate array (FPGA). As one example, the processor executes programs stored in a memory, such as RAM (which may be the storage unit 11). A group of processors may be called a “multiprocessor” or simply a “processor”.

The storage unit 11 stores node information 13. The node information 13 associates a plurality of nodes, such as nodes 14a, 14b, and 14c, with a plurality of behavior sets, such as behavior sets 15a, 15b, and 15c. A node represents a decision-making body in a simulation, and is sometimes referred to as a “player”. The nodes may correspond to physical devices, such as computers. A behavior set includes two or more behaviors that may be selected by a node. Behaviors are sometimes referred to as “strategies”, and behavior sets are sometimes referred to as “strategy sets”.

The behavior set 15a indicates behaviors that may be selected by the node 14a. As one example, the behavior set 15a includes behaviors A, B, and C. The behavior set 15b indicates behaviors that may be selected by the node 14b. As one example, the behavior set 15b includes the behaviors A, B, and D. The behavior set 15c indicates behaviors that may be selected by the node 14c. As one example, the behavior set 15c includes the behaviors A, E, and F. In this way, different behavior sets may include the same behaviors. Note that it is preferable for the behavior sets 15a, 15b, and 15c to include the same number of behaviors.

The processing unit 12 calculates an approximate solution for a probability distribution for behaviors selected by the nodes 14a, 14b, and 14c under simulation conditions indicated by the node information 13. A behavior set that has been assigned a probability distribution is sometimes referred to as a “mixed strategy”. First, the processing unit 12 determines a group 16 including two or more nodes out of the plurality of nodes, based on the similarity between the plurality of behavior sets indicated by the node information 13. As one example, the processing unit 12 detects two or more behavior sets including a certain number or higher of the same behaviors, and sorts the two or more nodes corresponding to the detected two or more behavior sets into the group 16. In the example in FIG. 1, since the behavior sets 15a and 15b are similar, the processing unit 12 sorts the nodes 14a and 14b into the group 16.

The processing unit 12 assigns a behavior set 17 to the group 16. The assigned behavior set 17 is a behavior set for shared use by the nodes 14a and 14b included in the group 16 in place of the behavior sets 15a and 15b indicated by the node information 13. By doing so, behaviors that may be selected by the nodes 14a and 14b are shared. The behavior set 17 preferably includes the same number of behaviors as the behavior sets 15a and 15b.

The behavior set 17 may be the behavior set of any single node included in the group 16. This any single node may be the node with the lowest node number out of the two or more nodes included in the group 16. As one example, the behavior set 17 is the same as the behavior set 15a of the node 14a. In this case, the behavior set 17 includes the behaviors A, B, and C. As a result, the behaviors that may be selected by the node 14b are approximated by the behaviors that may be selected by the node 14a. However, the processing unit 12 may generate the behavior set 17 by combining the behavior sets 15a and 15b corresponding to the nodes 14a and 14b included in the group 16.

The processing unit 12 calculates an evaluation value for each of the two or more behaviors included in the behavior sets on which the nodes 14a, 14b, and 14c rely. The evaluation values are calculated based on an evaluation function decided in advance. The evaluation values may be referred to as “payoffs”, and the evaluation function may be referred to as a “payoff function”. At this time, for the group 16, the processing unit 12 calculates the evaluation values of the behaviors included in the behavior set 17 in place of calculating the evaluation values of the behaviors included in the behavior sets 15a and 15b. This reduces the number of behavior sets to be evaluated.

As one example, the processing unit 12 selects one behavior each for the nodes 14a, 14b, and 14c and calculates an evaluation value indicating the advantage of a given behavior based on the selected behaviors of the nodes 14a, 14b, and 14c. When doing so, the processing unit 12 may select a behavior for which an evaluation value is to be calculated from the behavior set 17, assign the behavior to the node 14a, select one behavior at random from the behavior set 17, and assign this selected behavior to the node 14b. When a probability distribution has already been assigned to the behavior set 17, the processing unit 12 may select one behavior according to this probability distribution. Selecting one behavior at random may be referred to as “sampling”.

For the node 14c that is not included in the group 16, the processing unit 12 may select one behavior at random from the behavior set 15c and assign the behavior to the node 14c. The node 14c may belong to another group, and the processing unit 12 may select one behavior at random from the behavior set corresponding to that other group and assign the selected behavior to the node 14c. The processing unit 12 calculates an evaluation value of the behavior selected by the node 14a based on the behavior selection described above.

The processing unit 12 calculates a probability distribution 18 in which the probabilities of two or more behaviors are listed based on the respective evaluation values of two or more behaviors included in the behavior set 17. The sum of the probabilities of the two or more behaviors is 1. As the algorithm that calculates the probability distribution 18, the processing unit 12 may use replicator dynamics or regret minimization dynamics.

As one example, the processing unit 12 calculates the average of the evaluation values of the two or more behaviors included in the behavior set 17. The average evaluation value may be a weighted average evaluation value produced by weighting individual evaluation values by their probabilities. The processing unit 12 increases the probability of a behavior whose evaluation value is above the average evaluation value and decreases the probability of a behavior whose evaluation value is below the average evaluation value. As one example, the processing unit 12 interprets the difference between the evaluation value of a certain behavior and the maximum evaluation value out of two or more behaviors included in the behavior set 17 as a regret, and updates the probabilities of the respective behaviors so that the average regret decreases.

As one example, the probability distribution 18 indicates that the probability of the behavior A is 60%, the probability of the behavior B is 30%, and the probability of the behavior C is 10%. The nodes 14a and 14b included in the group 16 are assumed to stochastically select one behavior from the behavior set 17 according to the probability distribution 18. In this case, calculation of a probability distribution corresponding to the behavior sets 15a and 15b indicated by the node information 13 may be omitted. It is also possible to interpret this as the processing unit 12 copying the probability distribution 18 calculated for the node 14a to the node 14b.

Note that the processing unit 12 may repeatedly update the evaluation value of each behavior included in the behavior set 17 and update the probability distribution 18 corresponding to the behavior set 17. For the node 14c, which is not included in the group 16, the processing unit 12 may also calculate an evaluation value for each behavior in the behavior set on which the node 14c relies and calculate a probability distribution for this behavior set.

The processing unit 12 outputs equilibrium solutions for the probability distributions of the behaviors selected by the nodes 14a, 14b, and 14c. The same equilibrium solution is calculated for the nodes 14a and 14b included in the group 16. The processing unit 12 may display the equilibrium solutions on the display apparatus, store the equilibrium solutions in non-volatile storage, and/or transmit the equilibrium solutions to another information processing apparatus.

As described above, the information processing apparatus 10 according to the first embodiment sorts a plurality of nodes indicated by the node information 13 into a group based on similarity of behavior sets. The information processing apparatus 10 assigns a shared behavior set to nodes included in the same group. Instead of calculating evaluation values for the behaviors included in individual behavior sets, the information processing apparatus 10 calculates evaluation values for the behaviors included in the shared behavior set for a group, and calculates the probability distribution for the shared behavior set. By doing so, there is a reduction in the number of behavior sets to be evaluated, and the load of calculating evaluation values is reduced.

By grouping nodes that have similar behavior sets, such as nodes for which a certain number or more of the behaviors are the same, the equilibrium solution for the case where grouping is not performed is approximated with high accuracy. By using the behavior set of any one node included in a group as the behavior set of that group, the sharing of a behavior set within a group is simplified. Also, when calculating the evaluation value of a certain behavior, by selecting the behaviors of other nodes from the behavior set by sampling, the accuracy of the evaluation value is maintained and the number of executions of the evaluation function is suppressed. By repeatedly calculating evaluation values and updating the probability distribution, a highly accurate equilibrium solution is calculated.

### Second Embodiment

A second embodiment will now be described.

In a situation where each of a plurality of players stochastically selects one strategy with the aim of maximizing a payoff, the mixed strategies of the players may converge on a certain equilibrium solution through competition. An information processing apparatus 100 according to the second embodiment searches for this equilibrium solution through simulation. This search for an equilibrium solution performed by the information processing apparatus 100 may be applied to analysis and institutional design of a large-scale social system, such as a supply chain.

The information processing apparatus 100 executes a dynamics algorithm, such as replicator dynamics or regret minimization dynamics, to calculate an equilibrium solution for mixed strategies. The information processing apparatus 100 may be a client apparatus or a server apparatus. The information processing apparatus 100 may be referred to as a “computer”, an “equilibrium solution searching apparatus”, or a “simulation apparatus”. The information processing apparatus 100 corresponds to the information processing apparatus 10 according to the first embodiment.

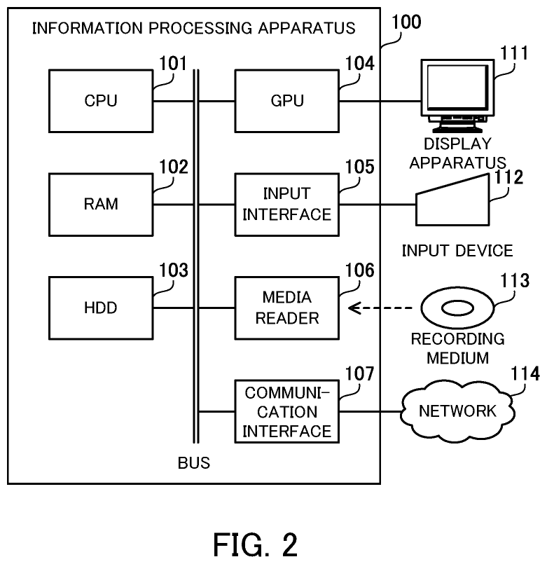

FIG. 2 is a block diagram depicting example hardware of an information processing apparatus.

The information processing apparatus 100 includes a CPU 101, a RAM 102, an HDD 103, a GPU 104, an input interface 105, a media reader 106, and a communication interface 107 that are connected to a bus. The CPU 101 corresponds to the processing unit 12 in the first embodiment. The RAM 102 or the HDD 103 corresponds to the storage unit 11 in the first embodiment.

The CPU 101 is a processor that executes instructions of a program. The CPU 101 loads at least part of a program and data stored in the HDD 103 into the RAM 102 and executes the program. The information processing apparatus 100 may include a plurality of processors. A group of processors may be referred to as a “multiprocessor” or simply as a “processor”.

The RAM 102 is a volatile semiconductor memory that temporarily stores a program to be executed by the CPU 101 and data used for computation by the CPU 101. The information processing apparatus 100 may include another type of volatile memory aside from RAM.

The HDD 103 is non-volatile storage that stores software programs, such as an operating system (OS), middleware, and application software, as well as data. The information processing apparatus 100 may include other types of non-volatile storage, such as flash memory or a solid state drive (SSD).

The GPU 104 performs image processing in cooperation with the CPU 101 and outputs images to a display apparatus 111 connected to the information processing apparatus 100. As examples, the display apparatus 111 is a cathode ray tube (CRT) display, a liquid crystal display, an organic electro luminescence (EL) display, or a projector. Note that the information processing apparatus 100 may be connected to another type of output device, such as a printer.

The GPU 104 may also be used as a general purpose computing on graphics processing unit (GPGPU). The GPU 104 may execute a program according to instructions from the CPU 101. The information processing apparatus 100 may also include volatile semiconductor memory aside from the RAM 102 as GPU memory used by the GPU 104.

The input interface 105 receives an input signal from an input device 112 connected to the information processing apparatus 100. As examples, the input device 112 is a mouse, a touch panel, or a keyboard. A plurality of input devices may be connected to the information processing apparatus 100.

The media reader 106 is a reader apparatus that reads programs and data recorded on a recording medium 113. As examples, the recording medium 113 is a magnetic disk, an optical disc, or a semiconductor memory. Magnetic disks include flexible disks (FD) and HDD. Optical discs include compact discs (CD) and digital versatile discs (DVD). The media reader 106 copies the program and data read from the recording medium 113 into another recording medium, such as the RAM 102 or the HDD 103. The read program may be executed by the CPU 101.

The recording medium 113 may be a portable recording medium. The recording medium 113 may be used to distribute programs and data. The recording medium 113 and the HDD 103 may also be referred to as “computer-readable recording media”.

The communication interface 107 communicates with other information processing apparatuses via a network 114. The communication interface 107 may be a wired communication interface connected to a wired communication apparatus, such as a switch or a router, or may be a wireless communication interface connected to a wireless communication apparatus, such as a base station or an access point.

Next, a supply chain will be described as one example of a simulation.

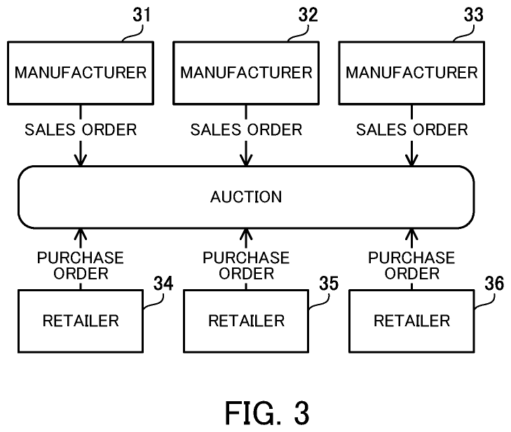

FIG. 3 depicts one example of players in a simulation.

The supply chain includes manufacturers 31, 32, and 33 and retailers 34, 35, and 36 as players. The manufacturers 31, 32, and 33 purchase raw materials from a raw material producer, manufacture products, and sell the products to the retailers 34, 35, and 36. The retailers 34, 35, and 36 purchase products from the manufacturers 31, 32, and 33 and sell the products to consumers.

The information processing apparatus 100 calculates transaction prices and transaction volumes determined through transactions between the manufacturers 31, 32, and 33 and the retailers 34, 35, and 36. The transactions between the manufacturers 31, 32, and 33 and the retailers 34, 35, and 36 are modeled by a double auction in which desired transaction prices and transaction volumes of the respective players are specified. The manufacturers 31, 32, and 33 transmit sales orders which each specify a desired sales price and a desired sales volume. The retailers 34, 35, and 36 transmit purchase orders which each specify a desired purchase price and a desired purchase volume.

The manufacturers 31, 32, and 33 and the retailers 34, 35, and 36 each have a mixed strategy relating to a desired transaction price and a desired transaction volume, and stochastically select one pure strategy from their own mixed strategy. The strategies that each player may select are defined in advance. The probability distribution for the mixed strategy of each player is calculated by a dynamics algorithm, such as replicator dynamics or regret minimization dynamics.

When updating the mixed strategy of a certain player, the information processing apparatus 100 refers to the mixed strategies of other players at that time and calculates the respective payoffs of the plurality of strategies included in the mixed strategy of that player. The payoffs indicate the advantage of each strategy based on the mixed strategies of other players at that time. A payoff calculation, in which a plurality of players select one strategy each and one payoff of each player is determined, may be regarded as a single game. The information processing apparatus 100 updates the probability distribution for the mixed strategy by calculating the probability of each strategy based on the dynamics algorithm and the calculated payoffs. The information processing apparatus 100 repeats the calculation of payoffs and the updating of the probability distribution for the plurality of players.

The raw material producer and the consumers are non-players. However, the raw material prices of the raw materials sold by the raw material producer fluctuate randomly according to a normal distribution defined in advance and correspond to an external environment where the manufacturers 31, 32, and 33 do not have control. In addition, the demanded volume of products purchased by the consumers fluctuates randomly according to a normal distribution defined in advance and corresponds to an external environment where the retailers 34, 35, and 36 do not have control. The information processing apparatus 100 determines the raw material prices and demanded volume for each transaction using random numbers.

The payoffs of the manufacturers 31, 32, and 33 are the differences between the product sales to the retailers 34, 35, and 36 and the raw material purchase cost from the raw material producer. The payoffs of the retailers 34, 35, and 36 are the differences between the product sales to the consumers and the product purchase cost from the manufacturers 31, 32, and 33. The information processing apparatus 100 calculates the payoffs for when thirty transactions (as one example, one transaction per day for thirty days) have been continuously performed under the same strategy. There are cases where product inventory is left at the retailers 34, 35, and 36 due to insufficient demand. This product inventory is carried over to the following day.

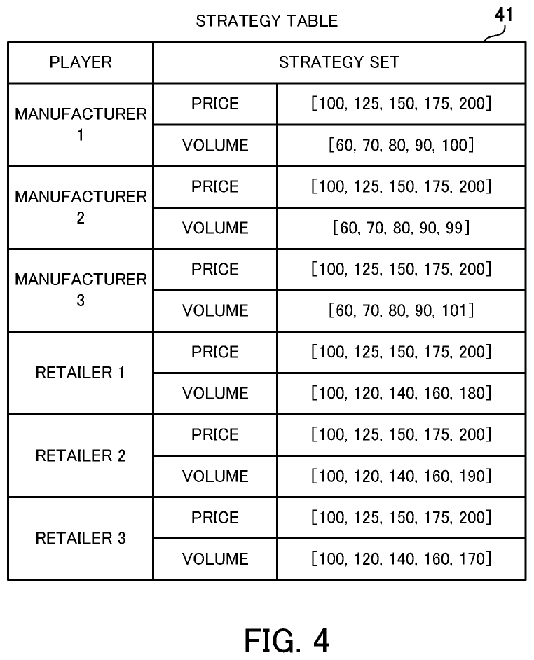

FIG. 4 depicts one example of a strategy table.

A strategy table 41 depicts strategy sets of players. Different players may have the same strategy set, or different players may have different strategy sets. The strategy sets of different players may include strategies that are the same.

In the example supply chain in this second embodiment, the manufacturers 31, 32, and 33 and the retailers 34, 35, and 36 each have twenty-five strategies defined by combinations of five prices and five volumes. Each strategy is expressed by a two-dimensional vector. The manufacturers 31, 32, and 33 and the retailers 34, 35, and 36 have respectively different strategy sets. However, the strategy sets of the manufacturers 31, 32, and 33 include strategies that are the same, and therefore resemble each other. Similarly, the strategy sets of the retailers 34, 35, and 36 include strategies that are the same, and therefore resemble each other.

The strategies of the manufacturer 31 each include a sales price selected from 100, 125, 150, 175, and 200 and a sales volume selected from 60, 70, 80, 90, and 100. The strategies of the manufacturer 32 each include a sales price selected from 100, 125, 150, 175, and 200 and a sales volume selected from 60, 70, 80, 90, and 99. The strategies of the manufacturer 33 each include a sales price selected from 100, 125, 150, 175, and 200 and a sales volume selected from 60, 70, 80, 90, and 101. Twenty out of the twenty-five strategies are the same between the manufacturers 31, 32, and 33.

The strategies of the retailer 34 each include a purchase price selected from 100, 125, 150, 175, and 200 and a purchase volume selected from 100, 120, 140, 160, and 180. The strategies of the retailer 35 each include a purchase price selected from 100, 125, 150, 175, and 200 and a purchase volume selected from 100, 120, 140, 160, and 190. The strategies of the retailer 36 each include a purchase price selected from 100, 125, 150, 175, and 200 and a purchase volume selected from 100, 120, 140, 160, and 170. Twenty out of the twenty-five strategies are the same between the retailers 34, 35, and 36. The strategy sets of the retailers 34, 35, and 36 include five strategies that are the same as the manufacturer 31.

When the manufacturers 31, 32, and 33 and the retailers 34, 35, and 36 have each selected a strategy, an appropriate transaction price and appropriate transaction volumes are determined by an auction. The transaction volume will differ between players, but the transaction price is determined as a common market price for the plurality of players. This market price may be determined according to the “Itayose” method in Japanese securities trading.

As one example, the information processing apparatus 100 sorts the manufacturers 31, 32, and 33 in ascending order of desired sales price, and sorts the retailers 34, 35, and 36 in descending order of desired purchase price. The information processing apparatus 100 preferentially assigns sales rights to the highest ranked manufacturer, and preferentially assigns purchasing rights to the highest ranked retailer. The information processing apparatus 100 compares the desired sales price of the manufacturer with the sales rights and the desired purchase price of the retailer with the purchasing rights and, when the desired sales price is equal to or lower than the desired purchase price, establishes a transaction between the manufacturer and the retailer. The transaction volume is the smaller of an unsatisfied portion of the desired sales volume and an unsatisfied portion of the desired purchase volume.

When the desired sales volume of the manufacturer with the sales rights is completely satisfied by establishment of a transaction, the information processing apparatus 100 assigns the sales rights to the manufacturer with the next highest ranking. Likewise, when the desired purchase volume of the retailer with the purchasing rights is completely satisfied by an establishment of a transaction, the information processing apparatus 100 assigns the purchasing rights to the retailer with the next highest ranking. When the desired sales volumes of all of the manufacturers 31, 32, and 33 are satisfied, or when the desired purchase volumes of all of the retailers 34, 35, and 36 are satisfied, the information processing apparatus 100 ends the auction. The information processing apparatus 100 also ends the auction when the desired prices are incompatible and no more transactions may be established.

The respective transaction volumes of the manufacturers 31, 32, and 33 and the retailers 34, 35, and 36 are the transaction volumes of the transactions established for each player via the procedure described above. On the other hand, the transaction prices of the manufacturers 31, 32, and 33 and the retailers 34, 35, and 36 are the single market price calculated from how the transactions were established. When the total of the desired sales volumes of the manufacturers 31, 32, and 33 is less than the total of the desired purchase volumes of the retailers 34, 35, and 36, the transaction price is the desired purchase price of the final retailer to have the purchasing rights. When the total of the desired sales volumes is greater than the total of the desired purchase volumes, the transaction price is the desired sales price of the final manufacturer to have the sales rights.

Using the payoff function described above, the information processing apparatus 100 searches for an equilibrium solution for the mixed strategies reached through competition between the manufacturers 31, 32, and 33 and the retailers 34, 35, and 36. This equilibrium solution represents an equilibrium state where for every player, there is no improvement in payoff even when the mixed strategy of that player is changed. The equilibrium solution corresponds to an evolutionarily stable strategy in replicator dynamics and a coarse correlation equilibrium in regret minimization dynamics.

When replicator dynamics is used, the information processing apparatus 100 calculates, for each strategy set, the average payoff of the plurality of strategies included in that strategy set. The average payoff is a weighted average payoff obtained by weighting the payoff of each strategy by the probability of that strategy at that point in time. Note that the probability distribution in the initial state is a uniform distribution, where the plurality of strategies have the same probability. When the number of strategies is twenty-five, the initial probability of each strategy is 4%. The information processing apparatus 100 updates the probability of each strategy in the plurality of strategies using the ratio of an individual payoff to the average payoff as a multiplier. The probability of a strategy whose payoff is above the average payoff is increased and the probability of a strategy whose payoff is below the average payoff is decreased.

When regret minimization dynamics is used, the information processing apparatus 100 calculates, for each strategy set, a regret for each of the plurality of strategies included in that strategy set. The regret is the difference between the maximum payoff out of the plurality of strategies and an individual payoff, and corresponds to the lost profit caused by selecting a specific strategy. By decreasing the probability of each strategy in proportion to the regret, the information processing apparatus 100 updates the probability distribution so that the average regret of the plurality of strategies decreases.

When precisely calculating the payoff of each strategy in a certain generation, the information processing apparatus 100 exhaustively tries combinations of strategies selected by a plurality of players, and calculates an expected payoff by weighting payoffs by the probabilities of each combination occurring in that generation.

As one example, when the information processing apparatus 100 calculates the expected payoff of one strategy of the manufacturer 31, one strategy is selected for each of the manufacturers 32 and 33 and the retailers 34, 35, and 36 and one payoff is calculated based on that combination. The information processing apparatus 100 multiplies the probabilities of the five strategies selected by the manufacturers 32 and 33 and the retailers 34, 35, and 36 to calculate the probability of the present combination. The information processing apparatus 100 exhaustively tries combinations of the strategies of the manufacturers 32 and 33 and the retailers 34, 35, and 36 as described above, and weights the payoffs by the respective probabilities of the combinations to calculate the expected payoffs. The information processing apparatus 100 calculates the expected payoff of every strategy of the manufacturers 31, 32, and 33 and the retailers 34, 35, and 36.

However, when the expected payoffs are precisely calculated, there may be a huge increase in the number of payoff calculations. When N players (where N is an integer that is two or higher) each have n strategies (where n is an integer that is two or higher), the number of games taken to calculate the expected payoff of one strategy is n^{N-1}. The number of games to calculate the expected payoff of all strategies for all players is N×n^{N}. Since the manufacturers 31, 32, and 33 and the retailers 34, 35, and 36 each have twenty-five strategies, the number of games in this case is 6×25⁶=1,464,843,750.

For this reason, the information processing apparatus 100 reduces the number of payoff calculations by the following two approximation methods. As a first approximation method, the information processing apparatus 100 groups a plurality of players based on the similarity of their strategy sets and regards players belonging to the same group as having the same strategy set. By doing so, there is a reduction in the mixed strategies for which the payoffs are calculated and the probability distribution is updated, which results in a reduction in the number of payoff calculations.

As a second approximation method, instead of exhaustively extracting combinations of strategies of the other players, the information processing apparatus 100 samples the strategies of the other players from the strategy sets according to the probability distributions for a plurality of sampling iterations. The information processing apparatus 100 limits the number of sampling iterations to a number that is sufficiently smaller than the number of exhaustive combinations of strategies. When doing so, combinations with a low probability of occurring are unlikely to be tried. By doing so, the number of payoff calculations performed to calculate the expected payoff of one strategy is reduced. Note that the first approximation method is an approximation method that reduces the number of times the present player selects a strategy and the second approximation method is an approximation method that reduces the number of times other players select a strategy.

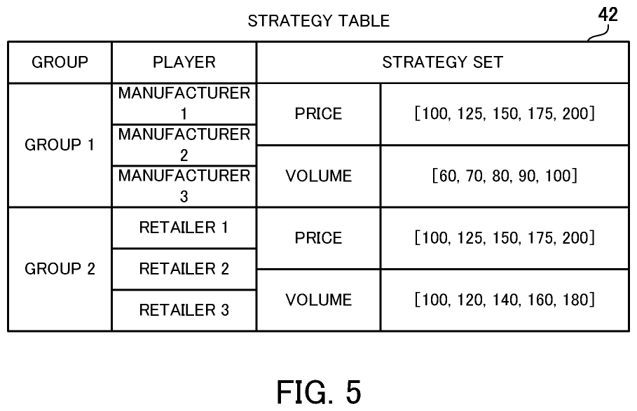

FIG. 5 depicts an example of a strategy table after grouping.

A strategy table 42 depicts the result of grouping the manufacturers 31, 32, and 33 and the retailers 34, 35, and 36 depicted in the strategy table 41. As described earlier, the strategy sets of the manufacturers 31, 32, and 33 include the twenty strategies that are the same, and the strategy sets of the retailers 34, 35, and 36 include twenty strategies that are the same. On the other hand, the strategy sets of the retailers 34, 35, and 36 include only five strategies that are the same as the manufacturer 31 and do not include any of the same strategies as the manufacturers 32 and 33. For this reason, based on the similarity of the strategy sets, the information processing apparatus 100 sorts the manufacturers 31, 32, and 33 into a first group and the retailers 34, 35, and 36 into a second group.

The information processing apparatus 100 assigns one strategy set to each group. In the second embodiment, the information processing apparatus 100 uses the strategy set of any player included in a group as the strategy set of that group. As one example, the information processing apparatus 100 uses the strategy set of the player with the lowest identification number out of the players in the group. In the strategy table 42, the strategy set of the first group is the strategy set of the manufacturer 31 and the strategy set of the second group is the strategy set of the retailer 34.

By doing so, the information processing apparatus 100 may omit payoff calculations for the manufacturers 32 and 33 and the retailers 35 and 36. After calculating the probability distribution for the mixed strategies for the manufacturer 31, the information processing apparatus 100 copies the probability distribution to the manufacturers 32 and 33. This causes the manufacturers 32 and 33 to stochastically select strategies from the same strategy set as the manufacturer 31 according to the same probability distribution as the manufacturer 31. When the information processing apparatus 100 has calculated the probability distribution for the mixed strategy of the retailer 34, the information processing apparatus 100 copies the probability distribution to the retailers 35 and 36. This causes the retailers 35 and 36 to stochastically select strategies from the same strategy set as the retailer 34 according to the same probability distribution as the retailer 34. Note that in the second embodiment, it is preferable for the number of strategies to be the same for each player.

The information processing apparatus 100 groups a plurality of players as follows based for example on the number of strategies that are the same. First, the information processing apparatus 100 initializes a value m to m=1 (where m is an integer that is one or greater). The information processing apparatus 100 generates one or more groups according to a policy of sorting two or more players with m or more strategies that are the same into the same group. As one example, the information processing apparatus 100 generates a power set including every strategy by listing the strategies of all of the players with duplicates removed. The information processing apparatus 100 extracts a combination of strategies with a size of m or greater from the power set, extracts players who have this combination, and groups the extracted players. The information processing apparatus 100 removes duplication in the generated groups and specifies one or more unique groups.

The information processing apparatus 100 determines whether there is a player who is included in two or more groups. When there are no players included in two or more groups, the information processing apparatus 100 uses the groups produced by sorting using the current value of m. When there are players who are included in two or more groups, the information processing apparatus 100 increases m by one and repeats the grouping process. By doing so, the information processing apparatus 100 may sort the players into the lowest possible number of groups in a range where the strategy sets of different groups are not similar.

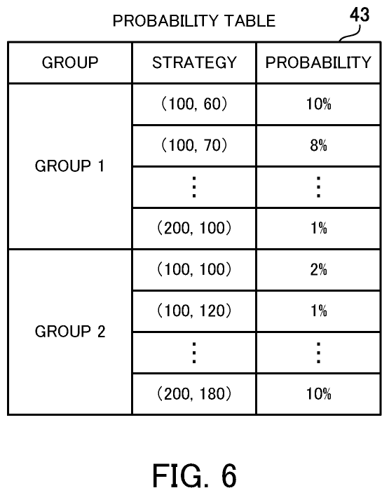

FIG. 6 depicts one example of a probability table.

A probability table 43 depicts a probability distribution calculated during a search for an equilibrium solution. The first group has twenty-five strategies defined by the prices 100, 125, 150, 175, and 200 and the volumes 60, 70, 80, 90, and 100. The information processing apparatus 100 calculates the respective probabilities of these twenty-five strategies. As examples, the probability of the strategy with a price of 100 and a volume of 60 is 10%, the probability of the strategy with a price of 100 and a volume of 70 is 8%, and the probability of the strategy with a price of 200 and a volume of 100 is 1%. The manufacturers 31, 32, and 33 share a mixed strategy defined by this strategy set and probability distribution.

The second group has twenty-five strategies defined by the prices 100, 125, 150, 175, and 200 and the volumes 100, 120, 140, 160, and 180. The information processing apparatus 100 calculates the respective probabilities of these twenty-five strategies. As examples, the probability of the strategy with a price of 100 and a volume of 100 is 2%, the probability of the strategy with a price of 100 and a volume of 120 is 1%, and the probability of the strategy with a price of 200 and a volume of 180 is 10%. The retailers 34, 35, and 36 share a mixed strategy defined by this strategy set and probability distribution.

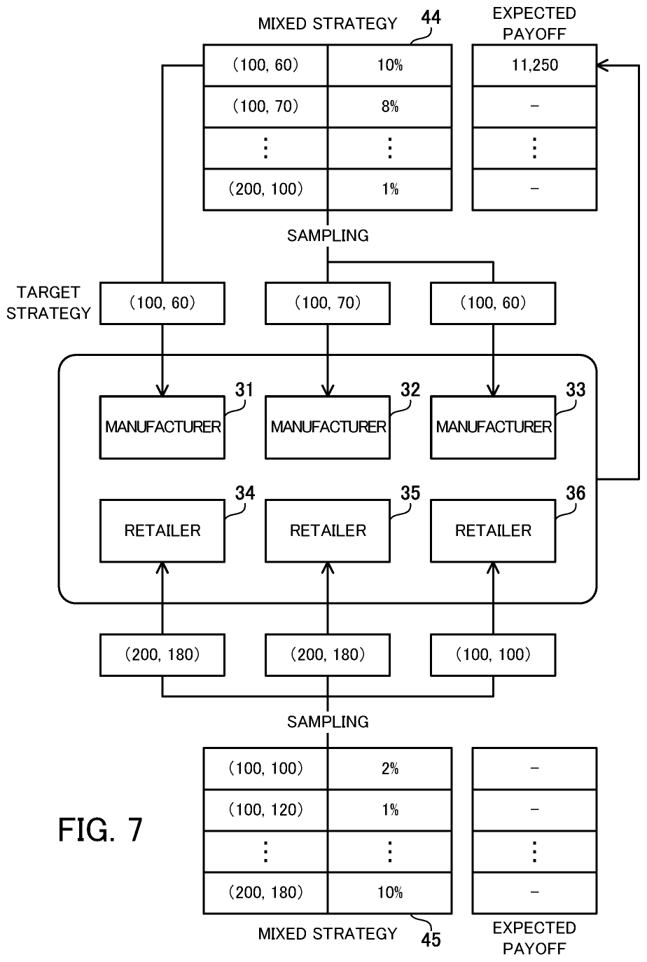

FIG. 7 depicts an example sampling of strategies from a mixed strategy.

Here, an example of calculating the payoff of one strategy in the first group will be described. The first group has a mixed strategy 44. The mixed strategy 44 indicates the strategy set that has been shared within the first group and the selection probabilities in the current generation of each strategy included in this strategy set. The second group has a mixed strategy 45. The mixed strategy 45 indicates the strategy set that has been shared within the second group and the selection probabilities in the current generation of each strategy included in this strategy set.

The information processing apparatus 100 selects a target strategy whose payoff is to be calculated from the mixed strategy 44 and assigns the target strategy to the manufacturer 31. As one example, the information processing apparatus 100 assigns the strategy with a price of 100 and a volume of 60 to the manufacturer 31. The information processing apparatus 100 also performs sampling on the mixed strategy 44 to select one strategy per manufacturer and assigns the selected strategies to the manufacturers 32 and 33. As one example, the information processing apparatus 100 assigns the strategy with a price of 100 and a volume of 70 to the manufacturer 32 and assigns the strategy with a price of 100 and a volume of 60 to the manufacturer 33.

In addition, the information processing apparatus 100 performs sampling on the mixed strategy 45 to select one strategy per retailer and assigns the selected strategies to the retailers 34, 35, and 36. As one example, the information processing apparatus 100 assigns strategies with a price of 200 and a volume of 180 to the retailers 34 and 35 and assigns a strategy with a price of 100 and a volume of 100 to the retailer 36.

During sampling, one strategy is selected at random according to the probability distribution. From the mixed strategy 44, the strategy with a price of 100 and a volume of 60 is selected with a probability of 10%, the strategy with a price of 100 and a volume of 70 is selected with a probability of 8%, and the strategy with a price of 200 and a volume of 100 is selected with a probability of 1%. From the mixed strategy 45, the strategy with a price of 100 and a volume of 100 is selected with a probability of 2%, the strategy with a price of 100 and a volume of 120 is selected with a probability of 1%, and the strategy with a price of 200 and a volume of 180 is selected with a probability of 10%.

The information processing apparatus 100 calculates the sales price and the sales volume of the manufacturer 31 based on the selected desired transaction prices and desired transaction volumes selected by the manufacturers 31, 32, and 33 and the retailers 34, 35, and 36 using a payoff function indicating an auction. The information processing apparatus 100 calculates the payoff of the manufacturer 31 from the calculated sales price and sales volume.

Here, since the strategies of the manufacturers 32 and 33 and the retailers 34, 35, and 36 are selected by sampling, one calculation of the payoff of the manufacturer 31 is subject to chance. For this reason, the information processing apparatus 100 repeats sampling a plurality of times and calculates an expected payoff by averaging a plurality of calculated payoffs. The information processing apparatus 100 stores the calculated expected payoff as the expected payoff of the target strategy assigned to the manufacturer 31. As one example, the information processing apparatus 100 calculates the expected payoff of the strategy with the price of 100 and the volume of 60 as 11,250.

The information processing apparatus 100 calculates expected payoffs for every strategy included in the mixed strategy 44 using the manufacturer 31 as the present player as described above. In the same way, the information processing apparatus 100 calculates the expected payoffs for every strategy included in the mixed strategy 45 using the retailer 34 as the present player. When doing so, the strategies of the manufacturers 31, 32, and 33 and the retailers 35 and 36 as the other players are selected by sampling.

When sampling is performed, a combination with a high probability as the combination of the strategies of other players is highly likely to be tried a plurality of times. This mitigates the influence of random numbers on individual calculations of payoffs and improves the reliability of the expected payoff, compared to a case where all of the combinations are tried once.

Here, when the number of groups is g, the number of strategies in each group is n, and the maximum number of iterations of sampling is T, the maximum number of games taken to calculate the expected payoffs of every strategy in every group is g×n×T. When g=2, n=25, and T=100, the maximum number of games played is 2×25×100=5,000. Accordingly, the number of games is reduced to 1/300,000 compared to a case where grouping and sampling are not performed. Grouping reduces the number of games by a factor of 3, and sampling reduces the number of games by a factor of 100,000.

Next, the functions and processing procedure of the information processing apparatus 100 will be described.

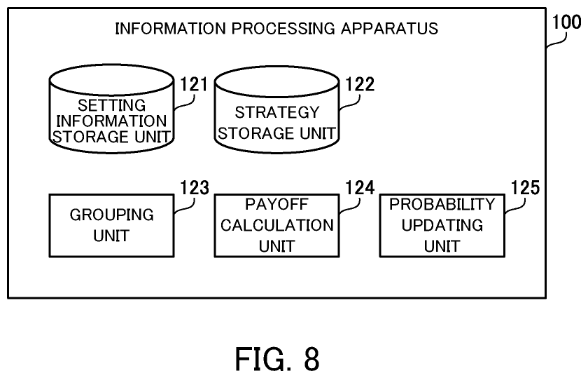

FIG. 8 is a block diagram depicting example functions of an information processing apparatus.

The information processing apparatus 100 includes a setting information storage unit 121, a strategy storage unit 122, a grouping unit 123, a payoff calculation unit 124, and a probability updating unit 125. The setting information storage unit 121 and the strategy storage unit 122 are implemented using the RAM 102 or the HDD 103, for example. As one example, the grouping unit 123, the payoff calculation unit 124, and the probability updating unit 125 are implemented using the CPU 101 and one or more programs.

The setting information storage unit 121 stores setting information. The setting information includes an initial strategy set for each of a plurality of players and a payoff function for calculating payoffs. As one example, the strategy table 41 is stored in the setting information storage unit 121. The setting information includes parameters such as an upper limit on the number of sampling iterations and an upper limit on generations of a mixed strategy.

The strategy storage unit 122 stores information on groups and strategy sets assigned to the respective groups. As one example, the strategy table 42 is stored in the strategy storage unit 122. The strategy storage unit 122 stores the payoffs calculated for each strategy in the groups and a probability distribution for the mixed strategy of each group. As one example, the probability table 43 is stored in the strategy storage unit 122.

The grouping unit 123 groups the plurality of players before commencement of the iterations that calculate the expected payoffs and update the probabilities. The grouping unit 123 sorts the plurality of players into groups based on similarity of the strategy sets defined in the setting information and shares one strategy set in each group. The players in the same group behave according to the same mixed strategy.

The payoff calculation unit 124 calculates the expected payoffs for every strategy in every group in each generation. When calculating the expected payoff of one strategy of a certain group, the payoff calculation unit 124 assigns that one strategy to one player and assigns strategies sampled according to the probability distribution to other players. The payoff calculation unit 124 calculates the payoff of that one player (the “present player”) using the payoff function. When doing so, it is possible to use random numbers indicating the external environment. The payoff calculation unit 124 calculates the expected payoff of that one strategy by repeatedly performing sampling.

The probability updating unit 125 updates the mixed strategies of every group based on the expected payoffs calculated by the payoff calculation unit 124 in each generation. As one example, the probability updating unit 125 adjusts the probability distribution according to replicator dynamics so that the probability of a strategy with a large expected payoff increases and the probability of a strategy with a small expected payoff decreases. On determining that the mixed strategies of every group have converged, the probability updating unit 125 stops the iterations and outputs the mixed strategies in this final generation as the equilibrium solutions. The probability updating unit 125 may display the equilibrium solutions on the display apparatus 111, store the equilibrium solutions in non-volatile storage, or transmit the equilibrium solutions to another information processing apparatus.

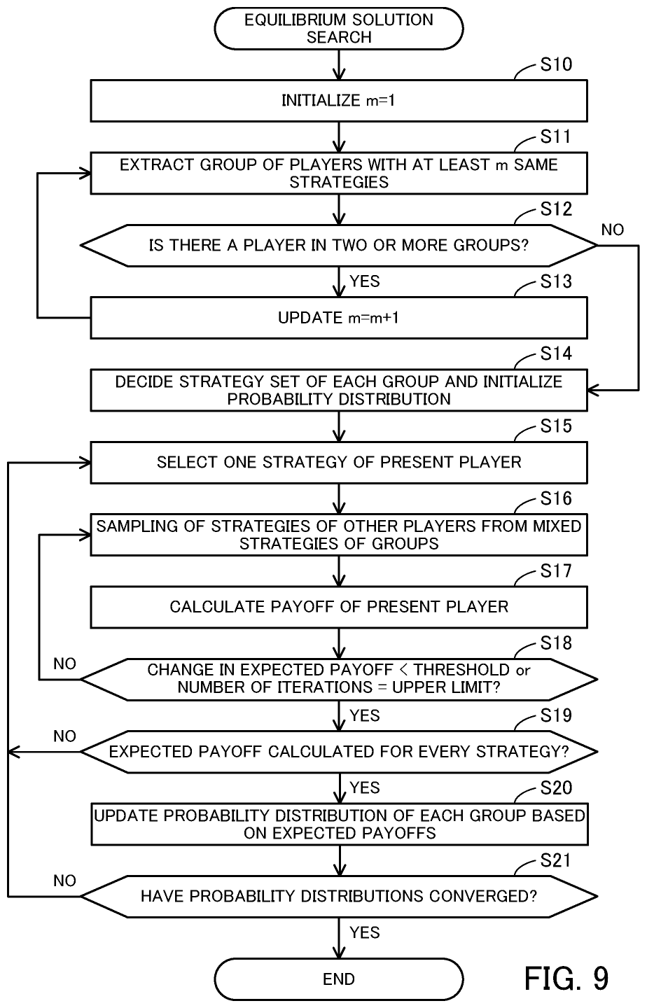

FIG. 9 is a flowchart depicting the processing procedure of a search for an equilibrium solution.

(S10) The grouping unit 123 performs initialization by setting m=1.

(S11) The grouping unit 123 analyzes the initial strategy sets of a plurality of players and exhaustively extracts a group of players with m or more strategies that are the same.

(S12) The grouping unit 123 determines whether there are players included in two or more of the groups extracted in step S11. When such a player exists, the processing proceeds to step S13. When no such players exist, the grouping unit 123 adopts the most recent grouping and the processing proceeds to step S14.

(S13) The grouping unit 123 increases m by 1, or in other words, updates m so that m=m+1. The processing then returns to step S11.

(S14) The grouping unit 123 determines, for each group, a shared strategy set for the group based on the initial strategy sets of the players included in the group. As one example, the grouping unit 123 adopts the strategy set of any one player in the group as a shared strategy set. The probability updating unit 125 initializes the probability distribution of each group. The initial probability distribution is a uniform distribution where the probabilities of every strategy are uniform.

(S15) The payoff calculation unit 124 selects one strategy in one group as a target strategy whose expected payoff is to be calculated. The payoff calculation unit 124 regards one player included in the group as the present player, and assigns the target strategy to the present player.

(S16) The payoff calculation unit 124 samples the strategies of every other player from the mixed strategies of the groups including the other players according to the probability distributions. The payoff calculation unit 124 assigns the sampled strategies to the other players.

(S17) The payoff calculation unit 124 calculates the payoff of the present player based on the strategies of the plurality of players and a payoff function that is defined in advance.

(S18) The payoff calculation unit 124 averages one or more payoffs calculated by iterations of steps S16 and S17 for the target strategy in step S15 to calculate the expected payoff at the present time. The payoff calculation unit 124 determines whether the change in the expected payoff compared to the previous calculation of expected payoff is below a threshold, or whether the number of iterations of steps S16 and S17 has reached the upper limit. The former condition indicates whether the expected payoff has converged. When either of these conditions is satisfied, the processing proceeds to step S19, and when neither condition is satisfied, the processing returns to step S16.

(S19) The payoff calculation unit 124 determines whether an expected payoff has been calculated for every strategy in every group. When expected payoffs have been calculated for every strategy, the processing proceeds to step S20, and when there is a strategy for which an expected payoff has not been calculated, the processing returns to step S15.

(S20) The probability updating unit 125 updates, on a group-by-group basis, the probability distribution of two or more strategies included in the strategy set of the group based on the expected payoffs of the two or more strategies.

(S21) The probability updating unit 125 determines whether the probability distributions of all groups have converged. As one example, the probability updating unit 125 regards the probability distribution as a vector listing the probabilities of two or more strategies and calculates the Euclidean distance between the previous probability distribution and the current probability distribution for each group. The probability updating unit 125 determines that the probability distributions have converged when the distance is less than the threshold for every group. When the probability distributions have converged, the probability updating unit 125 outputs the mixed strategies with the converged probability distributions as the equilibrium solutions, and the search for equilibrium solutions ends.

When the probability distributions have not converged, the processing returns to step S15, and the payoff calculation unit 124 recalculates the payoffs of every strategy based on the updated probability distributions. However, the probability updating unit 125 may stop updating the probability distributions when the number of generations has reached the upper limit.

As described above, the information processing apparatus 100 according to the second embodiment groups a plurality of players based on the similarity of the initial strategy sets, and shares a single strategy set between the players within the same group. The information processing apparatus 100 then calculates one mixed strategy for each group, and regards the players in the group as behaving according to the same mixed strategy. This reduces the number of mixed strategies that are updated in each generation and reduces the number of payoff calculations. In addition, since the information processing apparatus 100 sorts players with similar strategy sets into the same group, an approximate solution for a mixed strategy may be calculated with high accuracy, even when a single strategy set is shared within a group.

When calculating the payoff of a certain strategy, the information processing apparatus 100 selects competitors' strategies at random according to probability distributions at that time. The information processing apparatus 100 calculates the expected payoffs of strategies with a smaller number of sampling iterations than when exhaustively extracting combinations of other players' strategies. By doing so, the number of payoff calculations is reduced while maintaining the accuracy of the expected payoffs. Since the strategies of other players are selected according to probabilities, payoffs are likely to be calculated a plurality of times for other players' strategies that have a high selection probability. This reduces the influence of random numbers on the expected payoffs, and means that expected payoffs with high reliability may be calculated efficiently with a low number of sampling iterations.

According to one aspect, it is possible for the present embodiments to reduce the load of calculating evaluation values during a search for an equilibrium solution.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing therein a computer program that causes a computer to execute a process comprising:
determining a group, which includes at least two nodes out of a plurality of nodes, based on similarity between a plurality of first behavior sets using node information which indicates the plurality of first behavior sets corresponding to the plurality of nodes, wherein each first behavior set includes at least two behaviors capable of being selected;
assigning a second behavior set to the group;
calculating an evaluation value for each behavior included in the second behavior set without calculating evaluation values for behaviors included in the at least two first behavior sets corresponding to the at least two nodes; and
calculating a probability distribution of the behaviors included in the second behavior set based on the evaluation values.

2. The non-transitory computer-readable recording medium according to claim 1,
wherein the determining of the group includes sorting the at least two nodes into the group when the at least two first behavior sets include at least a certain number of same behaviors.

3. The non-transitory computer-readable recording medium according to claim 1,
wherein the second behavior set is any one of the at least two first behavior sets.

4. The non-transitory computer-readable recording medium according to claim 1,
wherein the calculating of the evaluation value includes selecting, from the second behavior set and for a first node out of the at least two nodes, a target behavior whose evaluation value is to be calculated and selecting a behavior for a second node out of the at least two nodes at random from the second behavior set.

5. The non-transitory computer-readable recording medium according to claim 1,
wherein the calculating of the evaluation value includes:
repeating a calculation process that selects, from the second behavior set and for a first node out of the at least two nodes, a target behavior whose evaluation value is to be calculated, and selects a behavior for a second node out of the at least two nodes at random from the second behavior set; and
outputting, when a change between a result of a preceding iteration of the calculation process and a result of a present iteration of the calculation process is within a certain range, the result of the present iteration of the calculation process as the evaluation value.

6. The non-transitory computer-readable recording medium according to claim 1,
wherein the process further comprises:
updating the evaluation value of each behavior included in the second behavior set based on the probability distribution and updating the probability distribution of the behaviors included in the second behavior set based on the updated evaluation values.

7. A method of searching for an equilibrium solution comprising:
determining, by a processor, a group, which includes at least two nodes out of a plurality of nodes, based on similarity between a plurality of first behavior sets using node information which indicates the plurality of first behavior sets corresponding to the plurality of nodes, wherein each first behavior set includes at least two behaviors capable of being selected;
assigning, by the processor, a second behavior set to the group;
calculating, by the processor, an evaluation value for each behavior included in the second behavior set without calculating evaluation values for behaviors included in the at least two first behavior sets corresponding to the at least two nodes; and
calculating, by the processor, a probability distribution of the behaviors included in the second behavior set based on the evaluation values.

8. An information processing apparatus comprising:
a memory configured to store node information which indicates a plurality of first behavior sets corresponding to a plurality of nodes, wherein each first behavior set includes at least two behaviors capable of being selected; and
a processor configured to determine a group, which includes at least two nodes out of the plurality of nodes, based on similarity between the plurality of first behavior sets using the node information, assign a second behavior set to the group, calculate an evaluation value for each behavior included in the second behavior set without calculating evaluation values for behaviors included in the at least two first behavior sets corresponding to the at least two nodes, and calculate a probability distribution of the behaviors included in the second behavior set based on the evaluation values.
